(19) United States
(12) Patent Application Publication
(10) Pub. No.: US 2022/0252192 A1
(43) Pub. Date: Aug. 11, 2022

(54) CLAMPING COLLAR HAVING A RETAINING MEMBER AND A HOOK

(71) Applicant: CAILLAU, ISSY-LES-MOULINEAUX (FR)

(72) Inventors: Nicolas RIGOLLET, ROMORANTIN-LANTHENAY (FR); Abdelfettah ZINBI, ROMORANTIN-LANTHENAY (FR)

(21) Appl. No.: 17/666,636

(22) Filed: Feb. 8, 2022

(30) Foreign Application Priority Data
Feb. 9, 2021 (FR) 21 01217

(51) Int. Cl. F16L 23/036

(52) U.S. Cl. CPC F16L 23/036

(57) ABSTRACT

A clamping collar including a belt carrying a retaining member and a hook configured to hook onto the retaining member to define a hooked clamping state of the collar. The hook has a front wall and a running part which connects the front wall to the belt. The retaining member carries a first abutment member able, during the hooking of the hook onto the retaining member, to come into abutment with a second abutment member to define a maximum advanced position of the hook relative to the retaining member. The belt has at least one abutment wall member which has the second abutment member. The second abutment member is located, forwardly in the direction of movement of the hook towards the retaining member, at most in the area of connection of the belt to the hook.

### TECHNICAL FIELD

The present disclosure relates to a clamping collar, particularly a clamping collar of the type comprising a belt carrying a retaining member and a hook configured to hook onto the retaining member to define a hooked clamping state of the collar.

### BACKGROUND

Clamping collars of this type are well known, for example from patent applications EP 2 480 355, EP 0 627 591 or U.S. Pat. No. 5,353,478.

They are particularly used to clamp an object, for example to connect this object to another object. For example, the other object can be a tube made of a material such as metal, and the object which is connected thereto is a conduit, which is sleeved on the tube.

According to another example, the clamped object is formed by the ends of two axially connected tubes. For example, the tubes can be made of metal and have, at their ends, radially protruding bearing surfaces on the outer peripheries of the tubes, these bearing surfaces together forming a bulge when the tubes are abutted. The belt of the collar can have a recess which accommodates this bulge. For the clamping, the tubes are abutted and the collar is placed around their bearing surfaces so that they can be received in the recess. The bearing surfaces and the recess can be shaped so as to bring the bearing surfaces closer to each other when the belt is clamped. To this end, the recess of the collar can have a V- or U-shaped section with legs (forming flanks of the belt) folded back towards the axis of the belt and slightly inclined relative to a plane perpendicular to this axis, by moving away from each other towards their free ends close to the axis, and the bearing surfaces of the tubes can be inclined in the same way, so that the reduction in the diameter of the belt due to the clamping of the collar brings the bearing surfaces closer together.

These collars are generally satisfactory in many applications. However, for some demanding applications, particularly when the clamped object is hard, the closing of the collar can temporarily cause excessive clamping, which may adversely affect the performances of the collar. This can for example be the case when the collar is used to clamp a conduit made of hard material such as rigid plastic or metal on an endpiece, or when the tube is used to axially connect two metal tubes, in particular by clamping them through their metal bearing surfaces.

If the clamping of the collar on the clamped object is momentarily too intense, it can happen that some parts of the collar, particularly the hook, undergo plastic, that is to say non-reversible, deformations or that the clamped object undergoes plastic deformations or damage such as microcracks.

These phenomena, sometimes undetectable at the time of clamping, can adversely affect the performances of the clamping over time. For example, when the clamping collar is used to connect a fluid conduit on an endpiece or to connect two tubes for fluid, it can happen that the tightness of the assembly is no longer ensured.

Document FR2705410 attempts to propose a solution to this problem by providing that the retaining member is provided with an abutment capable of abutting with the inner face of the hook during the hooking of the hook behind the retaining member. Thus, during the clamping of the collar, the hook is moved so that the front wall of the hook is advanced over the retaining member until passing a retaining surface of the retaining member in order to be able to hook onto this surface, at the rear of the retaining member. When the hook is sufficiently advanced to allow this hooking, the abutments come into cooperation, in order to prevent the hook from advancing further.

This solution can be effective, but it can be difficult to ensure good quality and reliable abutment contact between the abutment and the inner face of the hook. If the clamping forces involved are high, this contact can be unstable and the inner face of the hook can then act as a sliding ramp for the abutment without actually retaining it. In addition, the abutment contact can tend to oppose the slight radial tilting of the hook inwardly which, once the front wall of the hook has passed the first abutment member, is necessary for the retention of the hooked hook behind the retaining member. Thus, this solution can adversely affect the hooking of the hook onto the retaining member.

### SUMMARY

The present disclosure aims to overcome at least in part the aforementioned drawbacks by ensuring to avoid, or at least to limit, the risks of over-clamping, particularly during the hooking of the hook onto the retaining member by being substantially exempt from the drawbacks of the aforementioned solution.

Thus, the disclosure relates to a clamping collar comprising a belt carrying a retaining member and a hook configured to hook onto the retaining member to define a hooked clamping state of the collar, the hook having a front wall and a running part which connects the front wall to the belt. The retaining member carries a first abutment member able, during the hooking of the hook onto the retaining member, to come into abutment with a second abutment member to define a maximum advanced position of the hook relative to the retaining member. The belt has at least one abutment wall element which has the second abutment member, and this second abutment member is located, forwardly in the direction of movement of the hook towards the retaining member, at most in the area of connection of the belt to the hook.

Thus, excessively advancing the hook during its hooking is avoided, which allows avoiding excessive clamping during this hooking. The integrity of the hook is therefore preserved by preventing it from being plastically deformed due to a momentarily excessive force during the hooking used to clamp the collar. At the same time, the collar being designed to be clamped on an object having a certain diameter, clamping this object too much is avoided by the fact that the abutment of the first and second abutment members corresponds to the specification diameter of the collar, which is predefined.

The abutment contact between the first and second abutment members is made outside the hook, particularly at the rear thereof, due to the location of the second abutment member. Thus, this contact does not concern the hook and is unlikely to impede its tilting which is necessary for its hooking onto the retaining member. It may not be degraded or lost either, due to the forces exerted on the hook, so that the risks of slipping are eliminated or at least considerably reduced.

Optionally, the first and second abutment members each have a first and a second abutment contact surface located on either side of a diametral plane of the belt, perpendicular to the axis of the latter.

Optionally, the belt comprises at least one flank which extends radially inwardly, the abutment wall element being formed in the flank.

Optionally, the belt has a recess delimited by two flanks which extend radially inwardly, the abutment wall element comprising two portions of abutment wall elements, respectively formed in each of these two flanks.

Optionally, said at least one flank is interrupted at the end of the belt which carries the hook so as to present an edge portion, and the second abutment member is formed on the edge portion.

Optionally, the flank is interrupted by a fold or a cutout.

Optionally, the retaining member has an extension which, in the hooked state, extends under the running part of the hook and which has the first abutment member.

Optionally, the extension has a stiffening relief.

Optionally, the retaining member comprises an outer radial protrusion.

It is understood that the first and second abutment members can thus be made in an extremely simple manner while fulfilling their function of defining the maximum advanced position of the hook relative to the retaining member at the moment of the hooking of the hook onto the retaining member and, more specifically, when the front wall of the hook passes at the rear of the retaining member to hook onto the latter, without risk of slipping between the abutment members and without adversely affecting the tilting of the hook necessary for the hooking. The collar is particularly made of metal, optionally in one piece, and the first and second abutment members can be made by simple folding, cutting and/or pressed into the metal material of the collar.

### BRIEF DESCRIPTION OF THE DRAWINGS

Other characteristics and advantages of the object of the present disclosure will emerge from the following description of embodiments, given by way of non-limiting examples, with reference to the appended figures.

FIG. 1 shows, in side elevation, a clamping collar according to the present disclosure, ready to be closed and clamped on an object.

FIG. 2 shows the collar upon its clamping on the object.

FIG. 2A is a view of detail II of FIG. 2, also in side elevation.

FIG. 2B is a view of detail II, seen in perspective taken from below, along the arrow JIB of FIG. 2.

FIG. 2C is a plan view of detail II seen from below, along the arrow JIB of FIG. 2.

FIG. 3 is a view of the collar of FIG. 2, in perspective taken from above.

FIG. 4 is a view similar to FIG. 2, showing one variant.

FIG. 4A is a view of detail IV of FIG. 4, in side elevation.

FIG. 4B is a view of detail IV, in perspective taken from below, along the arrow IVB of FIG. 4.

FIG. 4C is a plan view of detail IV seen from below, along the arrow IVB of FIG. 4.

FIG. 5 is a view of the collar of FIG. 4, in perspective taken from above.

### DETAILED DESCRIPTION

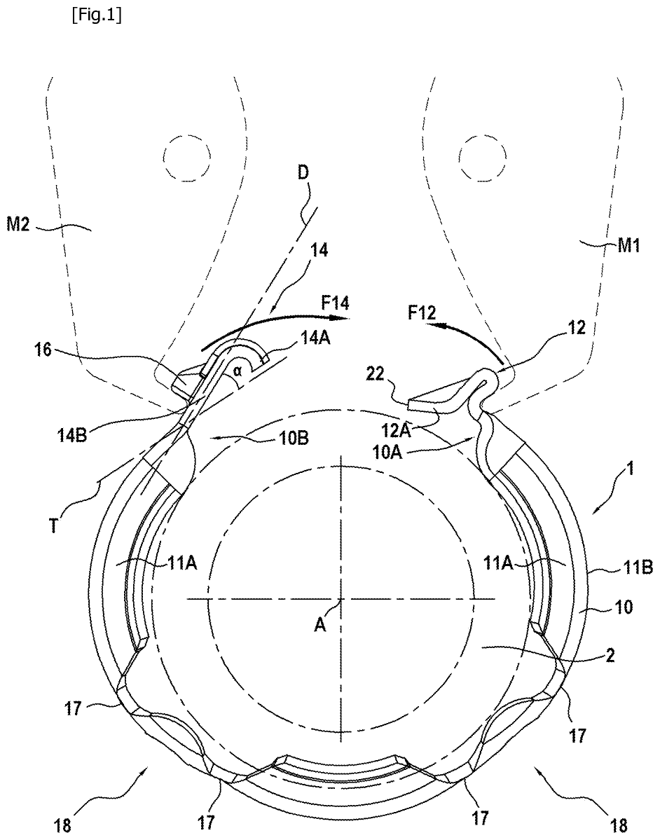

FIGS. 1, 2, 2A-2C and 3 will be described first.

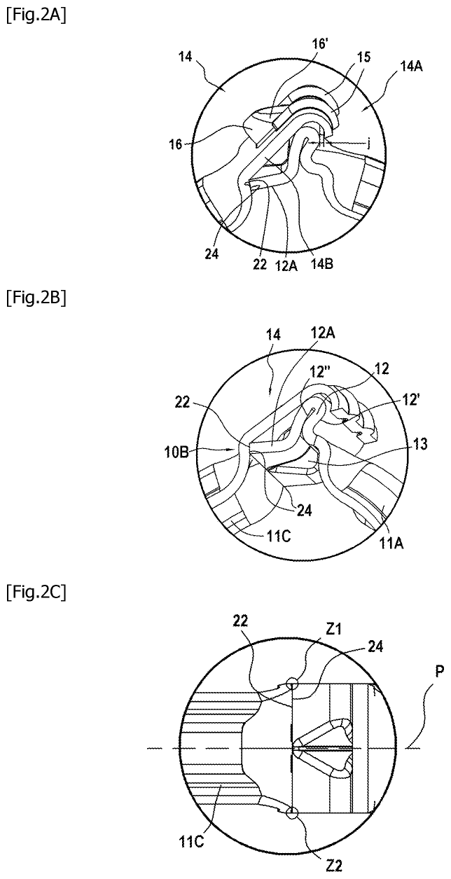

FIG. 1 shows a clamping collar 1 comprising a belt 10 having two ends, respectively 10A and 10B. The end 10A carries a retaining member 12, while the end 10B carries a hook 14 which is configured to hook onto the retaining member 12 to define a hooked clamping state of the collar shown in FIG. 2. In this case, the retaining member 12 is in outer radial protrusion relative to the outer periphery of the belt 10. In this case, it is a double fold formed outwardly.

Generally, in the clamped state of the collar, the belt 10 defines a circle of axis A, this axis being defined as being the axis of the clamping collar or the axis of its belt.

Within the meaning of the present disclosure, the outward or the upward direction is defined as being the direction moving away from this axis A. Conversely, the inward or the downward direction is the direction which moves closer to this axis A. Furthermore, it is understood that, in order to hook onto the retaining member, the hook 14 is moved in the direction of the arrow F14. Thus, by focusing on the hook, it will be considered that the forward direction is the direction defined by this arrow F14. In general, by focusing on the hook 14 or on the end 10B of the belt, the forward direction is the direction towards the retaining member 12 and the end 10A without passing through the belt. Likewise, during the hooking, the retaining member 12 is moved towards the hook in the direction F12. Thus, by focusing on the retaining member 12 and on the end 10A of the belt, the forward direction is defined as being the direction towards the end 10B of the hook 14 without passing through the belt 10.

The hook 14 has a front wall 14A and a running part 14B which connects the front wall 14A to the belt 10. In the clamped state of the collar, the front wall 14A is retained behind the retaining member 12, while a front part of the retaining member 12 is located under the running part 14B of the hook 14.

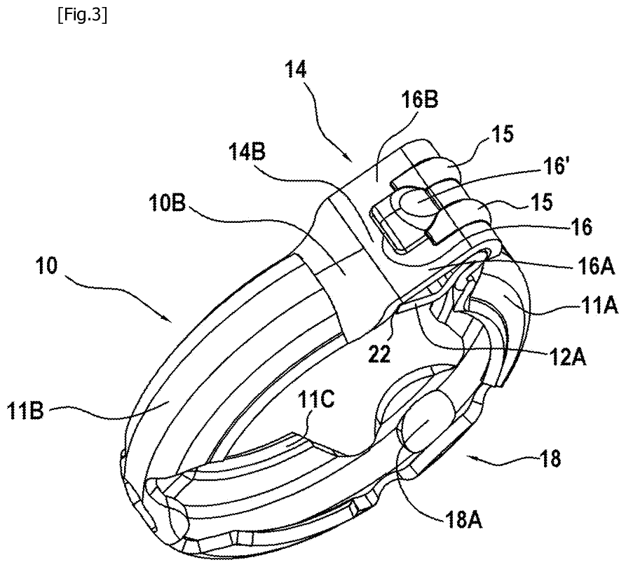

In this case, the hook 14 is of the type described in French patent application No. FR 19 10485 in the name of the Applicant, to which reference can be made. Particularly, the running part 14B of the hook has a gripping surface 16 protruding radially outwardly and two side borders 16A, 16B (see FIG. 3) which extend axially on either side of the gripping surface by being radially set back relative thereto. Here, axially is understood as being along the direction defined by the axis A. This gripping surface 16 is formed at the rear of a boss 16′ of the running part 14B of the hook. The front wall 14A of the hook has at least one, in this case two, stiffening ribs 15.

Thus, in the example represented, the running part 14B of the hook defines a substantially rectilinear general direction D, inclined by an angle α relative to the tangential direction T of the belt at the level of the connection of the hook to the end 10B of the belt (see FIG. 1). This angle α is for example on the order of 10 to 40 degrees, particularly on the order of 20 to 30 degrees. It is noted that the running part of the hook is connected to the end 10B of the belt without bend, particularly without projection.

However, the present disclosure can relate to other types of hooks, particularly a hook whose running part is defined by a radial undulation outwardly and/or whose area of connection to the end 10B of the belt is defined by a radial fold outwardly, for example as in the U.S. Pat. No. 5,353,478.

FIG. 1 shows the collar 1 during its clamping on an object 2 represented in broken lines. For example, this object 2 is the assembly of two ends of tubes connected axially. The collar 1 is clamped using a clamping tool, particularly pliers, two jaws of which respectively M1 which engages behind the retaining member 12, and M2 which engages on the hook 14 in this case behind its gripping surface 16, are seen.

According to the disclosure, the retaining member 12 carries a first abutment member 22 which, as can be seen in FIGS. 2, 2A and 2B, comes into abutment on a second abutment member 24 during the hooking of the hook 14 onto the retaining member 12 to define a maximum advanced position of the hook relative to the retaining member 12.

In this regard, it is pointed out that FIG. 2 shows the collar just at the moment of the hooking, when the front wall of the hook 14 passes behind the retaining member 12. While the abutment members 22 and 24 are in abutment, a very slight space indicated by a clearance j may exist at the rear of the retaining member 12, between the rear wall of this retaining member 12 and the inner face of the front wall 14A of the hook. It is understood that the abutment of the abutment members 22 and 24 defines the maximum advanced position of the hook 14 relative to the retaining member 12.

It can be seen from the figures that, in this case, the first abutment member is formed on an extension 12A of the retaining member 12 which extends forwardly relative to this retaining member 12 and which, in the hooked state, extends under the running part 14B of the hook. It can be in particular seen in FIG. 2B that this extension 12A can be connected to the radially protruding part of the retaining member 12 by one or several stiffening elements, such as a work hardening 13 forming a recess on the inside and a boss on the outside. In general, this work hardening forms a stiffening relief protruding either on the inner face or on the outer face of the extension 12A.

The retaining member 12 is formed in this case by a double radial fold with a rear fold portion 12′ connected to the end 10A of the belt, a front fold portion 12″ which carries the extension 12A (see FIG. 2B). The stiffening relief 13 is formed at the junction between the front fold portion 12″ and the extension 12A. The extension is offset radially inwardly relative to the top of the retaining member 12, by extending for example substantially in the extension of the peripheral direction of the belt 10. Thus, the extension 12A can extend substantially along the circumferential direction of the belt, beyond the retaining member 12 forwardly of this retaining member. Thus, as can be understood in particular in FIG. 2A, in the clamped state of the collar, the inner face of the extension 12A extends substantially circumferentially in the extension of the inner face of the belt. also possible that the extension is substantially planar and extends substantially tangentially to the circumferential direction of the belt, relative to the area of junction of the retaining member 12 to the end 10A of the belt.

The second abutment member 24 is for its part located in the belt 10, particularly, in the area of connection of the end 10B of the belt to the hook 14. Thus, as can be seen in FIG. 2A, this second abutment member 24 is located at the end 10B of the belt, in its area of transition with the running part 14B of the hook.

In this case, the collar represented is of the type in which the belt has a recess. Indeed, this belt 10 has at least one flank 11A which extends inwardly. In this case, the belt has two flanks, respectively 11A and 11C, which extend on either side of a central cylindrical region 11B (see FIG. 3). Thus, the belt generally has a U or V-shaped radial section with a crown part 11B, which forms the base of the U or the tip of the V and whose inner periphery defines the maximum internal diameter of the belt, and with two wings defining respectively two flanks 11A and 11C. This crown part 11B forms a central region, between the two flanks 11A and 11C. Indeed, the object 2 clamped by the collar can have a radial bulge, for example formed by the bearing surfaces of two axially connected tubes, received in the inner recess of the belt delimited between the flanks 11A and 11C. Thus, when it is indicated that the extension 12A of the retaining member 12 extends in the extension of the periphery of the belt, it is in fact considered that it extends in the extension of the crown part 11B of the section of the belt.

At the first end 10A of the belt, the flanks 11A and 11C are radially straightened to come substantially into the cylindrical surface defined by the central region 11B and form the retaining member 12 by folding. Likewise, at the second end 10B of the belt, the flanks 11A and 11C are straightened and it can be seen that the running part 14B of the hook is devoid of flanks, the continuity of their material then being located in the circumferential general direction defined by this running part 14B. Thus, at the end 10B of the belt, the flanks 11A and 11C are interrupted and have edge portions oriented towards the front of the hook 14.

The second abutment member 24 is formed in these edge portions of the flanks 11A and 11C. These flanks form abutment wall elements which, at the end 10B of the belt, form the second abutment member 24. More specifically, the second abutment member 24 is made in the edge portions of these flanks which form a transition area between these flanks and the hook. Thus, in this case, the second abutment member 24 is formed of the edge portions of the two flanks 11A and 11C which extend, in the area of connection of the hook to the end 10B of the belt, on either side of an axially median part of this connection area.

It is understood that the second abutment member comprises two parts, respectively located in the edge portions of each of the two flanks 11A and 11C. More specifically, as seen in FIGS. 2B and 2C, the first and second abutment members 22 and 24 each have a first and a second abutment contact surface Z1, Z2, which are located on either side of the diametral median plane P of the belt, perpendicular to its axis 1. The collar is moreover symmetrical relative to this plane P.

Thus, the abutment contact is distributed on either side of the plane P. It counteracts tilting relative to this plane and therefore operates correctly, even if the clamping tool is imperfectly positioned relative to the hook and to the retaining member.

Being formed in the flanks, which are areas in which the material is highly work hardened, the second abutment member is particularly resistant to the clamping forces.

This is all the more true when the second abutment member is formed in the edge portions of the flanks which are folded to bring the material of the flanks back into the plane of the central region 11B, these portions then being particularly highly work hardened. Moreover, these edge portions are perfectly delimited and therefore allow an accurate abutment contact.

In this case, the collar has capacity reserves formed by areas 18 of the belt located between regions 17 in which the flanks 11A and 11C are locally interrupted. The areas 18 forming the capacity reserve can have increased deformability, for example by having bores 18A or the like. From this point of view, the collar can be made as described in French patent application No. 19 10486, to which reference can be made.

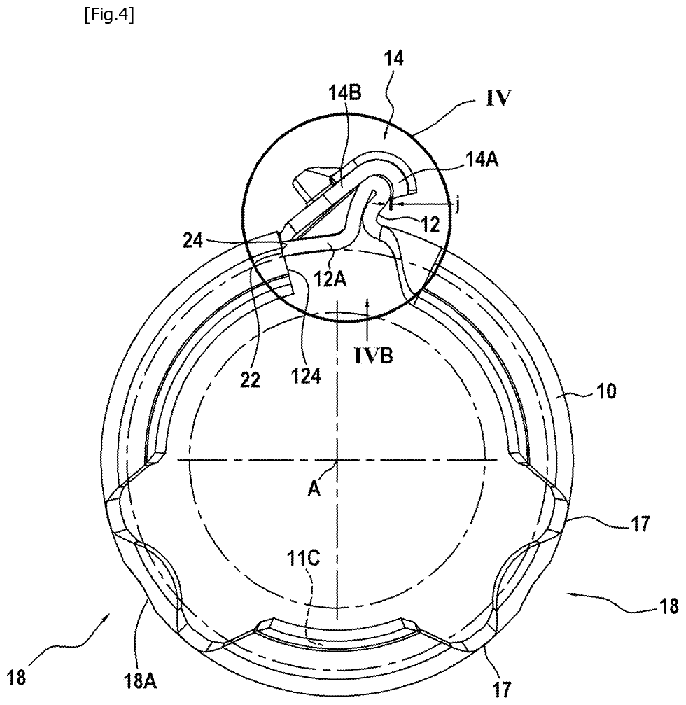

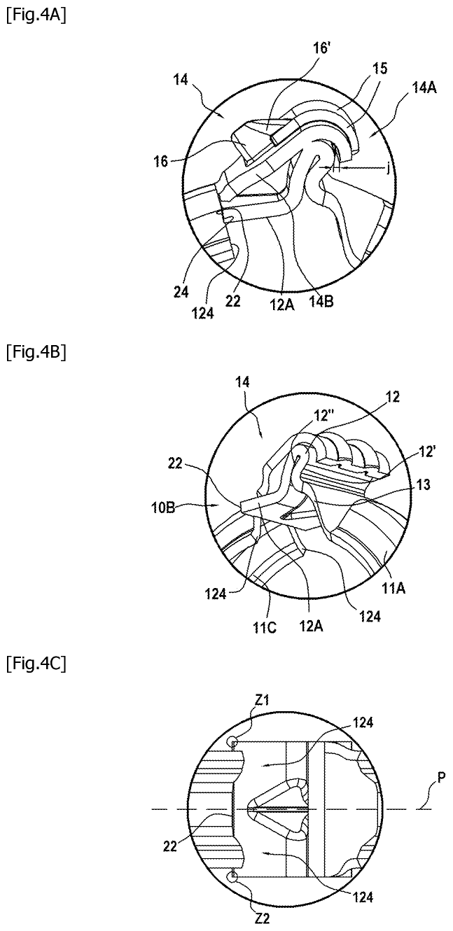

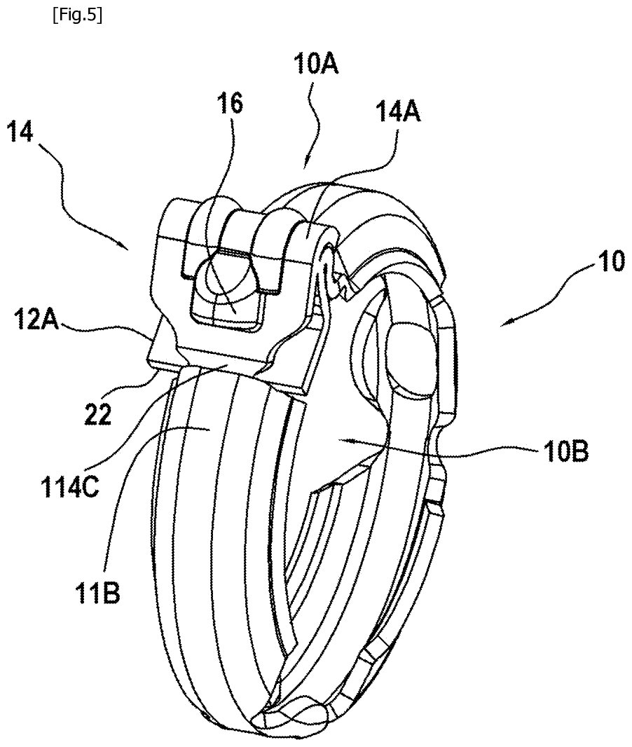

FIGS. 4, 4A-4C and 5 will now be described, which show one variant which differs from the collar which has just been described only by the conformation of the second abutment member. Thus, the same numeric references as in FIGS. 1, 2, 2A-2C and 3 are used in these figures except for those which designate the second abutment member.

In FIGS. 1, 2, 2A-2C and 3, the flanks are interrupted at the end 10B of the belt by folds which straighten them in the plane of the central region 11B.

In the variant of FIGS. 4, 4A-4C and 5, the flanks 11A and 11C are interrupted by cutouts. Thus, the edge portions in which the second abutment member 124 is formed are the cutting edges of the flanks, which are oriented substantially radially. As seen in FIGS. 4B and 4C, the collar is symmetrical relative to the diametral median plane P, which is perpendicular to the axis A of the belt, and the abutment contacts between the first and second abutment members 22 and 124 are made out on either side of the plane P.

The cutouts in the flanks 11A and 11C at the end 10B of the belt result in the belt being attached to the hook only through the central region 11B. However, from its rear end 114C thus attached to the belt, the hook can have a width (measured axially) which increases so that in its front part 14A, the hook benefits from the full width of the strip in which the collar is formed. This is shown in particular in FIG. 5. It can also be seen that, at the end 10A of the belt, the flanks are brought into the same plane to form the retaining member, as in the previous embodiment. However, it would of course also be possible to interrupt the flanks by cutting in this region.

The second abutment member is particularly resistant to the clamping forces because it is formed on the edges of the cutouts, which are generally oriented radially and therefore provide clean bearing surfaces difficult to deform. In addition, the positioning of the second abutment member is particularly accurate.

1. A clamping collar comprising a belt carrying a retaining member and a hook configured to hook onto the retaining member to define a hooked clamping state of the collar, the hook having a front wall and a running part which connects the front wall to the belt, the retaining member carrying a first abutment member able, during the hooking of the hook onto the retaining member, to come into abutment with a second abutment member to define a maximum advanced position of the hook relative to the retaining member, the belt comprising at least one abutment wall element, the second abutment member being located on the at least one abutment wall element and being located, in a forward direction of movement of the hook towards the retaining member, at most in an area of the belt where the belt connects to the hook.

2. The clamping collar according to claim 1, wherein the first and second abutment members each comprise a first and a second abutment contact surface located on either side of a diametral plane of the belt, perpendicular to the axis of the latter.

3. The clamping collar according to claim 1, wherein the belt comprises at least one flank which extends radially inwardly, the abutment wall element being formed in the flank.

4. The clamping collar according to claim 3, wherein the belt comprises a recess delimited by two flanks which extend radially inwardly, the abutment wall element comprising two portions of abutment wall elements, respectively formed in each of these two flanks.

5. The clamping collar according to claim 3, wherein said at least one flank is interrupted at the end of the belt which carries the hook so as to present an edge portion, and wherein the second abutment member is formed on the edge portion.

6. The clamping collar according to claim 5, wherein the flank is interrupted by a fold or a cutout.

7. The clamping collar according to claim 1, wherein the retaining member has an extension which, in the hooked state, extends under the running part of the hook and which has the first abutment member.

8. The clamping collar according to claim 7, wherein the extension has a stiffening relief.

9. The clamping collar according to claim 1, wherein the retaining member comprises an outer radial protrusion.

10. A clamping collar comprising a belt carrying a retaining member and a hook configured to hook onto the retaining member to define a hooked clamping state of the collar, the hook having a front wall and a running part which connects the front wall to the belt, the retaining member carrying a first abutment member able, during the hooking of the hook onto the retaining member, to come into abutment with a second abutment member to define a maximum advanced position of the hook relative to the retaining member, the belt comprising at least one flank which extends radially inwardly and at least one abutment wall element formed in the flank, the second abutment member being located on the at least one abutment wall element.

11. The clamping collar according to claim 10, wherein the second abutment member is located, in a forward direction of movement of the hook towards the retaining member, at most in an area of the belt where the belt connects to the hook.

12. The clamping collar according to claim 10, wherein the retaining member has an extension which, in the hooked state, extends under the running part of the hook and which has the first abutment member.
